(19) United States
(12) Patent Application Publication
(10) Pub. No.: US 2006/0068062 A1
(43) Pub. Date: Mar. 30, 2006

(54) Chocolate confectionary products and methods of preparing the same

(76) Inventors: Arthur N. Newman, Mamaroneck, NY (US); Eric H. Newman, North Miami Beach, FL (US)

Correspondence Address: AMSTER, ROTHSTEIN & EBENSTEIN LLP, 90 PARK AVENUE, NEW YORK, NY, 10016, US

(21) Appl. No.: 11/230,599

(22) Filed: Sep. 20, 2005

Related U.S. Application Data
(60) Provisional application No. 60/613,810, filed on Sep. 28, 2004.

(51) Int. Cl. A23L 1/36

(52) U.S. Cl. 426/93

(57) ABSTRACT

Provided are confectionary products comprising a substrate of a crispy food, a base coat of chocolate, an intermediate layer of a moist, creamy and flavored food substance, and an outer layer of chocolate, where the substrate is at least partially covered with the base coat, the base coat is at least partially covered with the intermediate layer, and the intermediate layer is covered by the outer layer, where the intermediate layer is encapsulated by the base coat and the outer layer. Methods of making these products are also provided.

### CROSS-REFERENCE TO RELATED APPLICATION

This application claims the benefit of U.S. Provisional Application No. 60/613,810, filed Sep. 28, 2004.

### BACKGROUND OF THE INVENTION

(1) Field of the Invention

The present invention relates generally to snack or confectionery foods and, more specifically, to multilayer, multi-textured, chocolate-coated products.

(2) Description of the Related Art

This invention relates generally to chocolate dipped, coated or enrobed confections. More specifically, it involves an attempt to combine confectionary products with baked or fried snack items offering a contrasting texture. Snack items such as hard pretzels, potato chips and graham crackers are crunchy. Thus, they have a distinctly different texture than chocolate, which, when properly prepared, offers a slight snap when bitten and melts at temperatures found inside the human mouth. Chocolate is often combined with a confectionary product having a moist and creamy texture, such as ganache. When this chocolate ganache is covered with chocolate, a confection commonly known as a truffle is created. This product offers two contrasting textures, that of the chocolate and that of the ganache. However, professional pastry chefs strive to achieve more than two contrasting textures in their creations.

Combining crispy snacks such as hard pretzels, potato chips and graham crackers with a creamy confection is therefore highly desirable. However, the combination is fraught with difficulties that have heretofore limited its applicability. Most prominently, if the creamy confection is placed in direct proximity with a crispy snack, over time moisture will be transferred from the creamy confection to the crispy snack, thereby degrading the characteristic and highly desired crisp texture. Additionally, even if the creamy confection is not in direct contact with the crisp item, if the creamy confection is not fully enclosed in a protective coating, in a sealed environment such as a bag, moisture may still be transmitted from the creamy confection to an exposed portion of the crisp item, degrading its texture. As a result of the foregoing, prior art has been generally limited to coating, dipping or enrobing crispy items such as pretzels, graham crackers and potato chips in chocolate confectionery coating or couverture. Properly tempered chocolate has a highly limited ability to absorb added moisture; as a result, the added external chocolate layer does not degrade the crispness of the base.

### SUMMARY OF THE INVENTION

In spite of the limitations of combining three items of contrasting texture, a crispy snack item, a moist and creamy confection, and chocolate, while preserving the unique texture and taste of each component, the inventors have developed a multilayer, multi-textured, chocolate-coated product wherein the base layer is crispy, an intermediate layer contains a moist and creamy filling, and layers of chocolate separate the intermediate and base layer, while fully enclosing the intermediate layer.

Thus, in some embodiments, the invention is directed to confectionary products comprising a substrate of a crispy food, a base coat of chocolate, an intermediate layer of a moist, creamy and flavored food substance, and an outer layer of chocolate. In these embodiments, the substrate is at least partially covered with the base coat, the base coat is at least partially covered with the intermediate layer, and the intermediate layer is covered by the outer layer. Additionally, the intermediate layer is encapsulated by the base coat and the outer layer.

In other embodiments, the invention is directed to confectionary products comprising a first pretzel in a rod shape, a base coat of chocolate, an intermediate layer of a moist, creamy and flavored food substance, and an outer layer of chocolate, where the base coat completely covers and circumscribes at least half of the pretzel, and the outer layer completely covers the intermediate layer. In these embodiments, the outer layer further comprises an edible decoration.

The invention is additionally directed to methods of manufacture of the above-described confectionary product. The methods comprise dipping, coating or enrobing the substrate with chocolate to form the chocolate base coat; then applying the intermediate layer by dipping the substrate/base coat combination into a bath of the intermediate layer or extruding the intermediate layer on top of the base layer; then encapsulating the base coat and intermediate layer with the outer layer by dipping, coating or enrobing the substrate/base coat/intermediate layer combination with chocolate.

In further embodiments, the invention is directed to methods of manufacture of the above confectionary product where the substrate is a pretzel. The methods comprise dipping, coating or enrobing the pretzel with chocolate to form the chocolate base coat; then applying the intermediate layer by extruding the intermediate layer on top of the base layer; then encapsulating the base coat and intermediate layer with the outer layer by dipping, coating or enrobing the pretzel/base coat/intermediate layer combination with chocolate.

### BRIEF DESCRIPTION OF THE DRAWINGS

FIG. 1 is a perspective view of a snack food formulated in accordance with the invention.

FIG. 2 is a perspective view of a snack food formulated in accordance with the invention, in which the alternative embodiment of two parallel pretzel rods is used.

FIG. 3 is an end view of the snack food shown in FIG. 1.

FIG. 4 is a sectional view of the snack food shown in FIG. 1, taken on line A-A of FIG. 1.

FIG. 5 is a sectional view of the snack food shown in FIG. 1, taken on line B-B of FIG. 1.

FIG. 6 is an alternative embodiment of a snack food formulated in accordance with the invention, substituting a graham cracker 8 for the pretzel 7.

FIG. 7 is a sectional view taken on line C-C of FIG. 6.

### DETAILED DESCRIPTION OF THE INVENTION

It is an object of this invention to create a new and hereunto unobvious and unnoticed food product. By combining the crispy snack, a moist and creamy intermediate layer, properly tempered chocolate and a decorative topping offering complementary texture and flavor, a new layered food product, with a unique combination of taste and multiple textures is thereby created. Further, the intermediate layer allows the introduction of a wide range of flavors which could not be otherwise achieved. Thus, a broad product line may be created, with similar texture and mouth-feel, but with flavors ranging from a deep rich chocolate, to creme brule, apricot brandy or coconut.

Accordingly, it is an additional object of this invention to create the means to facilitate the cross marketing of popular brand names through this hereunto unobvious and unnoticed market niche. Cross marketing of food items is an obvious trend, as can be clearly demonstrated by any trip to a grocery store. Brand name candies are lending their name to products ranging from breakfast cereal and baked snacks to frozen desserts. However, the same trip to a grocery store will also demonstrate that salty snacks such as pretzels and potato chips have not shared in this cross-marketing trend. Further, given that ganache commonly includes alcohol as an ingredient, there is a clear opportunity for cross-marketing with liquor companies.

The inventors have developed a multilayer, multi-textured, chocolate-coated product wherein the base layer is crispy, an intermediate layer contains a moist and creamy filling, and layers of chocolate separate the intermediate and base layer, while fully enclosing the intermediate layer.

Thus, in some embodiments, the invention is directed to confectionary products comprising a substrate of a crispy food, a base coat of chocolate, an intermediate layer of a moist, creamy and flavored food substance, and an outer layer of chocolate. In these embodiments, the substrate is at least partially covered with the base coat, the base coat is at least partially covered with the intermediate layer, and the intermediate layer is covered by the outer layer. Additionally, the intermediate layer is encapsulated by the base coat and the outer layer.

The substrate is not limited to any particular crispy food, but preferably it is a pretzel, a cracker or a potato chip. In more preferred embodiments, the substrate comprises a pretzel. Most preferably, the pretzel is in a rod shape, or two parallel rod-shaped pretzels. However, the pretzel can also be a knot, circle or any other shape within the art.

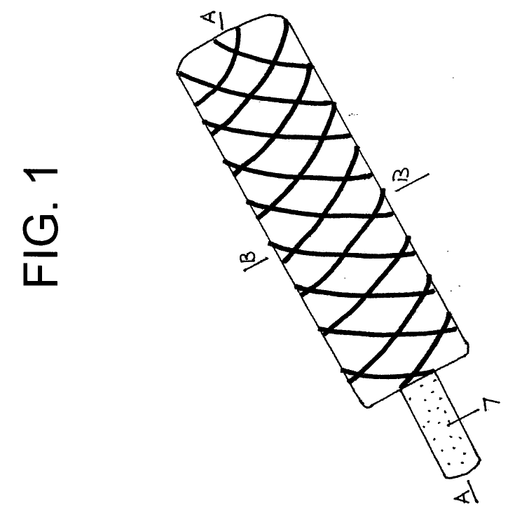

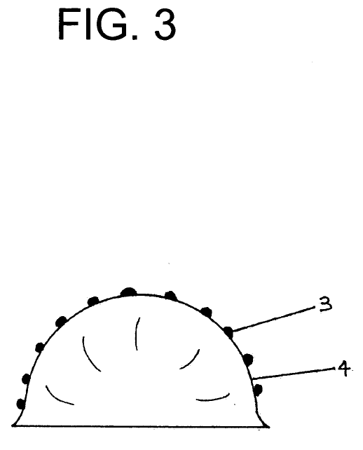

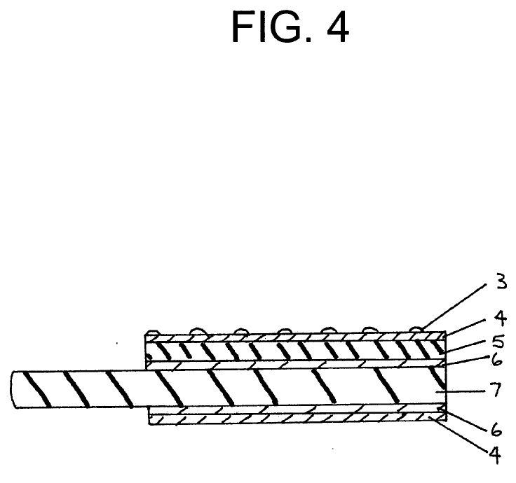

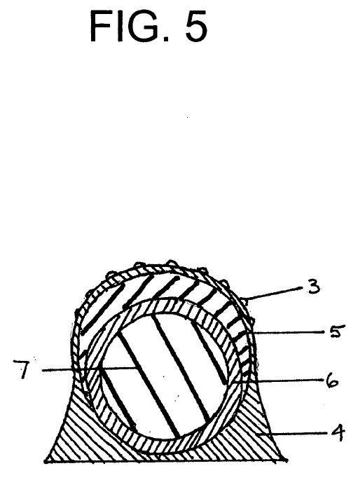

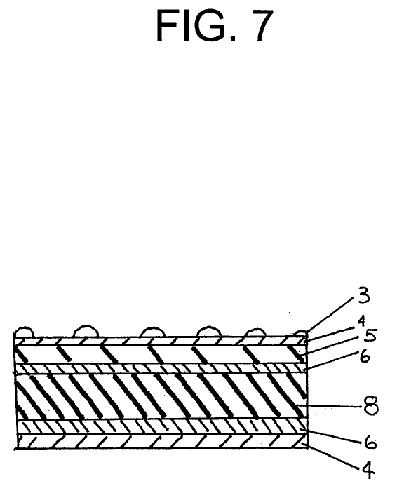

Referring now to FIGS. 1 through 7 of the drawing, preferred embodiments of the invention is illustrated.

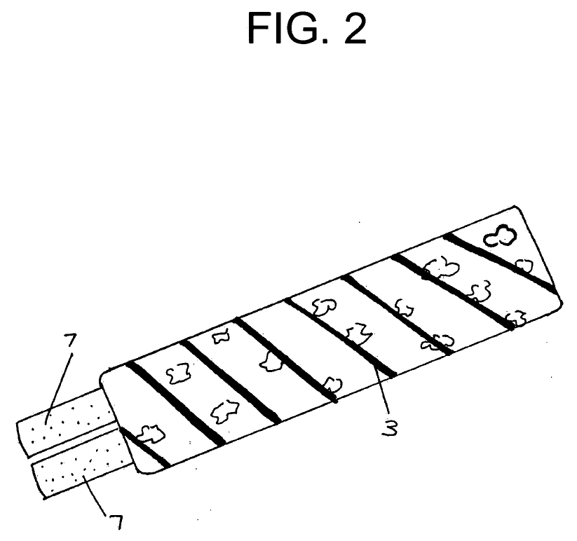

A base layer of chocolate 6, either compound coating or couverture, achieved by dipping, coating or enrobing the substrate. In some preferred embodiments, the crispy food is a pretzel or two parallel rod-shaped pretzels where the base coat completely covers and circumscribes at least half of the pretzel(s) (FIGS. 1 and 2).

One or more moist and creamy intermediate layer(s) of food 5 is external to the base layer. This intermediate layer is not limited to any particular moist and creamy food. Preferred intermediate layers are ganache, praline, fondant, fruit-based confection, or other similar moist and creamy confection.

The intermediate layer can also be flavored, for example to replicate or impart the taste of a brand name food confection, candy product or liquor. The intermediate layer can also comprise a small solid food item that affects the texture and taste of the intermediate layer.

Outside of the intermediate layer is one or more outer layers of chocolate 4, either confectionery coating or couverture, preferably achieved by dipping, coating or enrobing the substrate, base layer and intermediate layer. The outer layer can also have an edible decoration, such as lines or other shapes. These can be drawn by hand or machine using chocolate 3, and/or small food products 2, such as commercial sprinkles, nuts, cereal, beans, dried fruit, candies and broken cookies, attached to at least one side of the external layer of chocolate.

As desired, there may be additional intermediate layer-outer layer combinations outside of the first such combination.

In some preferred embodiments, the confectionary product comprises a first pretzel in a rod shape, a base coat of chocolate, an intermediate layer of a moist, creamy and flavored food substance, and an outer layer of chocolate, where the base coat completely covers and circumscribes at least half of the pretzel, and the outer layer completely covers the intermediate layer, and where the outer layer further comprises an edible decoration. These products can also comprise a second rod-shaped pretzel parallel and adjacent to the first pretzel, where the base coat completely covers and circumscribes at least half of each pretzels, and the outer layer completely covers the intermediate layer, and where the outer layer further comprises an edible decoration.

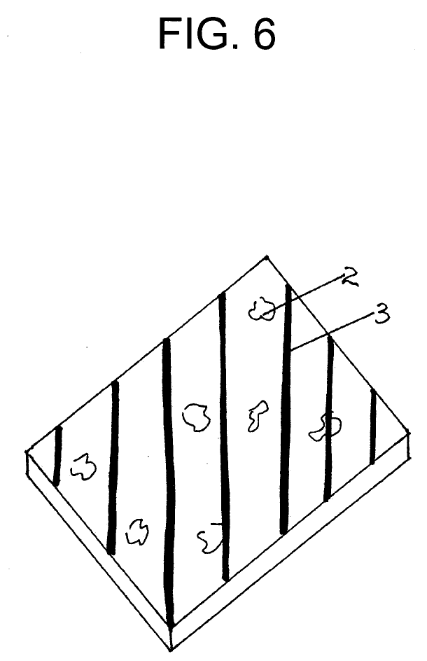

A preferred form of the snack item embodying the present invention is shown at FIG. 1. A variation of the preferred embodiment would be to use two or more rod pretzels 7, aligned in parallel, adhered to each other using chocolate. An example of this alternative embodiment utilizing two parallel pretzel rods is shown at FIG. 2. Additional variations on the preferred embodiment would substitute a potato chip or cracker, for the substrate. This alternative embodiment utilizing a graham cracker 8 as the substrate is shown in FIG. 6.

The pretzel 7 comprising the substrate may be any such commercially available product. Alternative embodiments may use commercially available potato chips as the substrate. Alternatively, there are many published references for producing potato chips including that found in “Joy of Cooking,” by Irma S. Rombauer, Marion Rombauer Becker and Ethan Becker, Scribner, New York, 1997, p. 144. Additional alternative embodiments may use commercially available crackers, including graham crackers 8, as the substrate.

The base layer(s) 6 and external layer(s) 4 of chocolate may be applied either by dipping, coating and/or enrobing the confection one or more times. The chocolate layers 4 and 6 may be comprised of tempered chocolate couverture, which must contain cocoa butter, or compound coating, which contains cocoa butter replacements or equivalents. There are multiple suppliers of such chocolate, including Archer Daniels Midland Company and Blommer. Among the many methods for tempering chocolate are those found in “Chocolate,” by Nick Malgieri, HarperCollins Publishers, Inc., New York, 1998, pp. 20-22; “Belgian Chocolates,” by Roger Geerts, Chocolate World nv, Belgium, pp. 25-26; and “A Formulary of Candy Products, 2nd Edition,” by Norman Harris, Chemical Publishing Co., New York, 1998, pp. 131 and 143. The characteristics, including the expected texture, of properly tempered chocolate are described in various texts, including “Chocolat,” by Alice Medrich, Warner Books, New York, 1990, p. 25.

The moist and creamy intermediate layer 5 of ganache, praline, fondant, fruit-based or other soft confection may be produced by a range of methods and recipes. Representative methods and recipes may be found in “Chocolate,” by Nick Malgieri, HarperCollins Publishers, Inc., New York, 1998, pp. 322-335; “Candymaking,” By Ruth Kendrick, HPBooks, New York, 1987, pp. 46-59; and “A Formulary of Candy Products, 2nd Edition,” by Norman Harris, Chemical Publishing Co., New York, 1998, pp. 310-357.

The present invention is also directed to methods of manufacture of the above-described confectionary product. The methods comprise dipping, coating or enrobing the substrate with chocolate to form the chocolate base coat; then applying the intermediate layer by dipping the substrate/base coat combination into a bath of the intermediate layer or extruding the intermediate layer on top of the base layer; then encapsulating the base coat and intermediate layer with the outer layer by dipping, coating or enrobing the substrate/base coat/intermediate layer combination with chocolate.

As stated above, the first step in assembling the described confection is applying the base layer(s) 6 to the substrate 7. In the process of adding the intermediate layer 5 to the already combined substrate and base layer, the temperature of the various layers is a key consideration. Optimally, the combined substrate and base layer should be 62-75° F. The intermediate layer 5 may be attached either by dipping the base layer in a bath of the intermediate layer or by extruding the intermediate layer on top of the base layer. Using either approach, the intermediate layer should not be too warm, with a recommended temperature of 70-81° F. The intermediate layer 5 may coat all or part of the combined substrate and base layers. The combined substrate, base layer and intermediate layer should be 62-75° F. when the external layer of chocolate 4 is applied. It is critical that the intermediate layer 5 be fully encapsulated by the base layer of chocolate 6 and the external layer of chocolate 4.

In the most preferred embodiments, the substrate/base coat combination is at 62-75° F. when the intermediate layer is applied, the intermediate layer is 70-81° F. when applied to the substrate/base coat combination, and the substrate/base coat/intermediate layer combination is 62-75° F. when the outer layer is applied.

The final product may be decorated by lines, squiggles, dots or other shapes drawn in chocolate 3 and/or decorated with food products 2. The food products may be commercially available decorations, such as sprinkles or colored sugar. The food products may also be commercially available items such as nuts, cereal, beans, dried fruit, candies, brownies or cookies, which may be used whole or broken or ground into smaller pieces. While the principal purpose of these toppings is to give the finished product a distinctive and attractive appearance, they may additionally impart one or more complementary flavors or textures.

In further embodiments, the invention is directed to methods of manufacture of the above confectionary product where the substrate is a pretzel. The methods comprise dipping, coating or enrobing the pretzel with chocolate to form the chocolate base coat; then applying the intermediate layer by extruding the intermediate layer on top of the base layer; then encapsulating the base coat and intermediate layer with the outer layer by dipping, coating or enrobing the pretzel/base coat/intermediate layer combination with chocolate.

In view of the above, it will be seen that the several advantages of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

What is claimed is:

1. A confectionary product comprising a substrate of a crispy food, a base coat of chocolate, an intermediate layer of a moist, creamy and flavored food substance, and an outer layer of chocolate,
wherein the substrate is at least partially covered with the base coat, the base coat is at least partially covered with the intermediate layer, and the intermediate layer is covered by the outer layer, wherein the intermediate layer is encapsulated by the base coat and the outer layer.

2. The confectionary product of claim 1, wherein the substrate comprises a pretzel, a cracker or a potato chip.

3. The confectionary product of claim 1, wherein the substrate comprises a pretzel.

4. The confectionary product of claim 3, wherein the pretzel is in a rod shape.

5. The confectionary product of claim 4, wherein the substrate consists of two parallel rod-shaped pretzels.

6. The confectionary product of claim 4, wherein the base coat completely covers and circumscribes at least half of the pretzel.

7. The confectionary product of claim 4, wherein the intermediate layer comprises a ganache, a praline, a fondant, or a fruit-based confection.

8. The confectionary product of claim 1, wherein the intermediate layer is flavored to replicate or impart the taste of a brand name food confection, candy product or liquor.

9. The confectionary product of claim 1, wherein the intermediate layer further comprises a small solid food item that affects the texture and taste of the intermediate layer.

10. The confectionary product of claim 1, wherein the outer layer further comprises an edible decoration.

11. A confectionary product comprising a first pretzel in a rod shape, a base coat of chocolate, an intermediate layer of a moist, creamy and flavored food substance, and an outer layer of chocolate,
wherein the base coat completely covers and circumscribes at least half of the pretzel, and the outer layer completely covers the intermediate layer, and
wherein the outer layer further comprises an edible decoration.

12. The confectionary product of claim 11, further comprising a second rod-shaped pretzel parallel and adjacent to the first pretzel,
wherein the base coat completely covers and circumscribes at least half of each pretzels, and the outer layer completely covers the intermediate layer, and
wherein the outer layer further comprises an edible decoration.

13. A method of manufacture of the confectionary product of claim 1, the method comprising
dipping, coating or enrobing the substrate with chocolate to form the chocolate base coat; then
applying the intermediate layer by dipping the substrate/base coat combination into a bath of the intermediate layer or extruding the intermediate layer on top of the base layer; then
encapsulating the base coat and intermediate layer with the outer layer by dipping, coating or enrobing the substrate/base coat/intermediate layer combination with chocolate.

14. The method of claim 13, wherein the substrate/base coat combination is at 62-75° F. when the intermediate layer is applied.

15. The method of claim 13, wherein the intermediate layer is 70-81° F. when applied to the substrate/base coat combination.

16. The method of claim 13, wherein the substrate/base coat/intermediate layer combination is 62-75° F. when the outer layer is applied.

17. The method of claim 13, wherein the substrate/base coat combination is at 62-75° F. when the intermediate layer is applied, the intermediate layer is 70-81° F. when applied to the substrate/base coat combination, and the substrate/base coat/intermediate layer combination is 62-75° F. when the outer layer is applied.

18. The method of claim 13, wherein, after adding the outer later, the product is decorated with a chocolate decoration.

19. The method of claim 13, wherein, after adding the outer later, the product is decorated with a food product.

20. A method of manufacture of the confectionary product of claim 11, the method comprising
dipping, coating or enrobing the pretzel with chocolate to form the chocolate base coat; then
applying the intermediate layer by extruding the intermediate layer on top of the base layer; then
encapsulating the base coat and intermediate layer with the outer layer by dipping, coating or enrobing the pretzel/base coat/intermediate layer combination with chocolate.
